(19) United States
(12) Patent Application Publication
(10) Pub. No.: US 2024/0401965 A1
(43) Pub. Date: Dec. 5, 2024

(54) METHOD FOR DETERMINING AN INTELLIGENT PRESELECTION OF SUITABLE CHARGING STATIONS FOR CARRYING OUT A CHARGING STOP, CHARGING STOP PLANNING ASSISTANT, AND VEHICLE

(71) Applicant: MERCEDES-BENZ GROUP AG, Stuttgart (DE)

(72) Inventors: Simon BREM, Sindelfingen (DE); Jörg ECHARD, Sindelfingen (DE); Martin KEPPLER, Oberreichenbach (DE); Dennis SCHWARZ, Bad Ditzenbach (DE)

(21) Appl. No.: 18/691,597

(22) PCT Filed: Jul. 27, 2022
(86) PCT No.: PCT/EP2022/071075

§ 371 Date: Mar. 13, 2024

(30) Foreign Application Priority Data
Sep. 14, 2021 (DE) 10 2021 004 631.5

(51) Int. Cl. G01C 21/36; B60L 53/62; G01C 21/34

(52) U.S. Cl. CPC G01C 21/3617; B60L 53/62; G01C 21/3461; G01C 21/3469; G01C 21/3484; G01C 21/3679

(57) ABSTRACT

A method for determining an intelligent preselection of suitable charging stations for involves providing an indication to perform a charging stop at a suitable charging station depending on a recorded variable in the form of at least one vehicle requirement, user requirement and/or environmental factor. A value of at least one vehicle requirement, user requirement, environmental factor, and/or a journey-specific factor deviating from the recorded variable is estimated by evaluating the recorded variable and at least one suitable charging station for carrying out the charging stop is suggested depending on the recorded variable and the estimated value by a comparison of the requirements and/or factors with at least one charging station-specific attribute.

### BACKGROUND AND SUMMARY OF THE INVENTION

Exemplary embodiments of the invention relate to a method for determining an intelligent preselection of suitable charging stations for carrying out a charging stop for charging a traction battery of an electrically drivable vehicle, a charging stop planning assistant, and a vehicle with an integrated charging stop planning assistant.

Battery-powered vehicles place more complex demands on a charging process for filling a vehicle's energy storage unit with energy than, for example, combustion vehicles powered by liquid fuel. While liquid fuel can be filled into a vehicle's tank comparatively quickly at a petrol pump, charging a traction battery of a battery-powered vehicle takes a comparatively long time. An electric charging station used for this purpose may also have a charging interface that is not compatible with the battery-powered vehicle. Furthermore, a network of electric charging stations is still comparatively limited compared to a petrol station network. An electric charging station is often already in use by another user. Additionally, a purely battery-powered vehicle often has a lower range than a combustion vehicle. For this reason, among others, a user of a battery-powered vehicle must plan a charging process at an electric charging station carefully so as not to lose any unnecessary time.

A device, a method, and a system for route planning for an electric vehicle are known from DE 10 2018 214 986 A2. With the aid of the route planning disclosed in the document, convenience for a person driving the electric vehicle is improved because charging stations close to or on the route are suggested for charging the traction battery of the electric vehicle. Thus, the need for the person driving the vehicle to find a charging station independently is eliminated. The charging stations suggested by the system are selected in such a way that the travel time for the person driving the vehicle to travel the route and the costs are minimized. The system estimates an expected charge level of the electric vehicle's traction battery. For this purpose, influencing factors such as climatic conditions, a route, and traffic volume are taken into account. Furthermore, a user of the vehicle can store user information such as appointments and/or leisure activities preferred by the user, whereupon the system preferentially selects charging stations in the vicinity of which leisure activities preferred by the user, such as a cinema, are located. A multi-criteria optimization is carried out to determine the selected charging stations, whereby individual weighting factors for individual criteria can be defined by the user. For example, the user can specify whether the proximity of a particular leisure activity to a charging station is particularly important for optimization and whether an electricity price plays a subordinate role.

DE 10 2016 123 669 A1 discloses the identification of acceptable vehicle charging stations. The document describes a method for characterizing charging stations with a third-party rating. The third-party rating is the rating of an overall impression of a specific charging station. The third-party rating consists of a primary assessment and a secondary assessment. The primary assessment corresponds to a school grade, for example a number such as 1, 3 or similar or a star rating, for example 5 stars. The secondary assessment comprises information relating to the charging station, such as security in the charging station region, existing attractions or establishments such as shops, restaurants or similar and a usefulness assessment, e.g., how many and which charging interfaces the charging station has, which electricity costs are involved, or similar. For convenient selection of suitable charging stations, a user can enter the minimum third-party rating that a charging station must have in order to be suggested for a charging process. If the charge level of the vehicle's traction battery continues to fall, charging stations with a lower third-party rating can also be automatically taken into account. A third-party rating can be given by any user of a charging station. The third-party rating can be input directly at the charging station, for example, via a mobile device such as a smartphone and/or via the vehicle's infotainment system. Input can also be made by voice. The system disclosed in the document is also capable of estimating a route travelled by the vehicle or learning the route from historical data, such as routes travelled by the vehicle in the past, if no navigation route is entered.

Furthermore, DE 10 2019 116 323 A1 discloses a journey planning method and a journey planning module. According to the method, a stop is recommended when either the vehicle has a need, such as a low fuel level or a low charge level of a traction battery, there is a user need such as the need to eat, drink or go to the toilet, and/or when an environmental factor is present. An environmental factor is, for example, the weather, dusk, approaching a mealtime or the like. According to the publication, the system is able to prioritize urgent needs from less urgent needs. To increase convenience for the person driving the vehicle, this person can use checkboxes to select certain facilities from a list that must be close to a charging station in order for the charging station to be suggested for a stop. For example, the person driving the vehicle can select a restaurant so that only charging stations near which a restaurant is located are suggested.

Exemplary embodiments of the present invention are directed to providing a method for determining an intelligent preselection of suitable charging stations for carrying out a charging stop for charging a traction battery of an electrically drivable vehicle, with the aid of which method convenience for a person driving the vehicle is improved when they are using their vehicle.

In a method for determining an intelligent preselection of suitable charging stations for carrying out a charging stop for charging a traction battery of an electrically drivable vehicle of the type mentioned at the beginning, an indication to carry out a charging stop is issued depending on a recorded variable in the form of at least one vehicle requirement, user requirement and/or environmental factor and, according to the invention, a value of at least one vehicle requirement, user requirement, environmental factor and/or a journey-specific factor deviating from the recorded variable is estimated by evaluating the recorded variable, and at least one suitable charging station for carrying out the charging stop is suggested depending on the recorded variable and the estimated value by comparing the requirements and/or factors with at least one charging station-specific attribute.

With the aid of the method according to the invention, a particularly convenient user experience for a person driving a vehicle is possible when using an electrically drivable vehicle. Thus, a value in the form of at least one vehicle requirement, user requirement, environmental factor and/or journey-specific factor can be estimated by evaluating the recorded variable, which enables the requirements of a user and/or their vehicle to be taken into account in a particularly convenient manner. This eliminates the need for a user to inform the vehicle that they themselves have a requirement. Furthermore, there is no need for a vehicle requirement to occur for it to be recorded. This means that vehicle requirements can be identified earlier than if vehicle requirements alone were recorded. This can accordingly be taken into account for the selection of the suitable charging station. This increases the probability that all existing requirements can be fulfilled when approaching a specific charging station, taking into account the existing factors.

Furthermore, at least one journey-specific factor can also be estimated from the recorded variable in the form of the vehicle requirement, user requirement and/or environmental factor. By taking a journey-specific factor into account, an even more suitable charging station for carrying out the charging stop can be suggested depending on the situation.

An advantageous development of the method provides that
a vehicle requirement is formed from: a charging level of a traction battery, a tire pressure, an oil temperature, a coolant temperature, and/or a defect of a vehicle component;
a user requirement is formed from: hunger, thirst, the need to urinate, fatigue, protection, and/or exhaustion;
an environmental factor is formed from: a time, a day of the week, a time of year, climate conditions, and/or the existence of a facility located up to a specified distance from the charging station in the proximity of the charging station; and/or.
a journey-specific factor is formed from: a route driven with the vehicle, a length of the route, a duration of time required to cover at least one section of the route, a seat occupancy, and/or a dwell time of the vehicle at a place.

Depending on the recorded variable and the estimated value, travelling to different charging stations can be associated with a different degree of fulfilment of requirements. If there is a vehicle requirement, for example because a traction battery needs to be charged, tire pressure needs to be topped up, a vehicle component needs to be repaired or similar, it makes sense to drive to a charging station near which the vehicle can be repaired and/or serviced. This means that the person driving the vehicle does not have to drive to a workshop that is far away from a charging station. This improves convenience for the person driving the vehicle.

If the person driving the vehicle is hungry or thirsty, it is advisable to go to a charging station where there is a snack bar, restaurant, or similar nearby. If the driver needs to go to the toilet, they can also use a toilet there. In the event of tiredness, exhaustion and/or the need for protection, it is advisable for the person driving the vehicle to go to a charging station near a hotel, for example, so that the person driving the vehicle can rest there.

Depending on the environmental factor, it may also make sense for the person driving the vehicle to visit certain charging stations and avoid certain charging stations. For example, the time of day and possibly the time of year can be used to determine whether it is daytime, morning, dusk, or night. If it is night or dusk, there may be a need to go to a charging station that is safe or at least perceived as safe. Such a charging station may be located in a neighborhood with a low crime rate and/or there may be public facilities or other facilities with a high density of people or activity in the vicinity of the charging station. A safe charging station can also be characterized by the presence of particularly extensive lighting. Depending on climatic conditions, for example during storms and/or rain, it may be practical for the person driving the vehicle to drive to a charging station with weather protection so as not to get wet during the charging process.

Depending on the route travelled by the vehicle, certain charging stations can also be displayed in preference and certain charging stations cannot be suggested for the charging stop. For example, only charging stations that are comparatively close to the route travelled by the vehicle are suggested. This reduces the time required for the person driving the vehicle to take a diversion to the charging station. If the vehicle has a dwell time at a location that exceeds a critical value, this dwell time can be used to charge the traction battery. However, if the vehicle remains at the location for a comparatively short time, it is not worth carrying out the charging process.

Other requirements and/or factors can also be estimated from the requirements and/or factors listed. If the traction battery is increasingly exhausted and needs to be charged, a charging station with the cheapest possible electricity price may be preferred to a charging station with a toilet after a journey time of 30 minutes. However, after a journey time of 4 hours until the traction battery is exhausted, the charging station with a toilet nearby may be preferred over a charging station with a favorable electricity price, as the person driving the vehicle and/or other vehicle occupants may have a strong urge to urinate in this case.

Taking the time of day into account, a charging station with a nearby restaurant and/or snack bar may be preferred at lunchtime, for example, and a charging station with a café nearby in the afternoon.

Taking the recorded variables into account, it is possible, for example, to estimate if it is the school holidays. For example, a current date, a navigation route and its length and/or a destination can be analyzed. By evaluating seat occupancy sensors, it is also possible to recognize whether, for example, other vehicle occupants such as the children of the person driving the vehicle are travelling with the vehicle. If this is the case, a particularly family-friendly charging station can be suggested, for example. Such a charging station is characterized, for example, by playgrounds and/or dog playgrounds located in the vicinity of the charging station.

By evaluating a destination, a dwell time can also be estimated. For example, if the vehicle stops near a trade fair, the person driving the vehicle may want to spend a day at the exhibition center. A comparatively long dwell time resulting from this is therefore suitable for charging the vehicle's traction battery.

Similarly, an estimated dwell time can be taken into account when planning a driving strategy. If a charging stop at a destination is probable, whereby probable means that a defined probability value, for example 80%, must be exceeded, the journey with the vehicle is planned so that the vehicle arrives at the destination with a comparatively low charge level of the traction battery, for example 10% residual capacity. If a comparatively short dwell time is expected, it is not possible to make a sensible charging stop. In this case, the journey is planned so that the vehicle arrives at its destination with a comparatively high residual capacity, for example 60%.

In such a scenario, it is not necessarily required that navigation is carried out by the vehicle. For example, the vehicle may be able to check its position independently and estimate a potential dwell time by taking into account facilities located in the vicinity of the vehicle, such as a trade fair, a workplace of the person driving the vehicle, the place of residence of the person driving the vehicle or similar. If the vehicle estimates that there is a long dwell time, the person driving the vehicle can be given an indication, for example in the form of an acoustic and/or visual warning, that now is a favorable moment to carry out the charging stop.

If, for example, a bakery or a post office is approached instead of a trade fair, a comparatively short dwell time can be expected. In this case, a possible charging stop is not expected and/or no charging stop is suggested.

According to a further advantageous embodiment of the method according to the invention, a charging station that has been visited at least once with the vehicle for charging is marked as a historical charging station, and charging stations marked as historical are preferably suggested for carrying out further charging stops. If the person driving the vehicle has already used a particular charging station to carry out a charging stop, it can be estimated from this that the person driving the vehicle has carried out a convenient charging stop at this particular charging station.

In general, the frequency with which the person driving the vehicle carries out charging stops at a specific charging station can be used to suggest these specific charging stations. The more often the person driving the vehicle makes a charging stop at a particular charging station, the greater the prioritization with which this charging station is suggested to the person driving the vehicle for making further charging stops. Examples of historical charging stations include a wallbox at the driver's place of residence, a charging station at the driver's place of work, a specific charging station at the driver's holiday destination or a charging station that is located on a frequently travelled route for the driver.

A further advantageous embodiment of the method according to the invention also provides that at least one attribute of a historical charging station is recorded and at least one charging station other than a historical charging station, which has the at least one attribute of the historical charging station, is preferably suggested for carrying out further charging stops. This further improves convenience for the person driving the vehicle when planning charging stops. The person driving the vehicle does not have to actively make any entries to inform a charging planning system of their preferences for carrying out charging stops. For example, if a particular charging station has a particularly favorable electricity tariff, is close to an ice cream parlor, has a particularly high charging capacity or similar, other charging stations with the same attributes can also be suggested, even if the person driving the vehicle has never visited such charging stations before.

Preferably, at least one of the following characteristics forms an attribute of a charging station:
a specific charging interface;
a specific current type, in particular a charging voltage, a charging current, a charging capacity, and/or a frequency;
an electricity price;
an operator of the charging station;
an energy supplier;
a bonus program;
a payment method;
existing weather protection;
a current, planned and/or an average occupancy;
available lighting; and/or
a facility existing up to a specific distance in the proximity of the charging station.

In general, the person driving the vehicle can also specify the distance up to which their preferred facility must be located in the vicinity of the charging station. For example, the person driving the vehicle can enter a distance of 10 meters, 100 meters or even one kilometer.

According to the invention, a charging stop planning assistant having a human-machine interface and a computer unit is set up to carry out a method described above. The person driving the vehicle can interact with the charging stop planning assistant via the human-machine interface. For example, the charging stop planning assistant comprises a display such as a display for outputting information, and operating elements such as a touch screen, a touch field, buttons, switches, rotary controls, or the like for inputting operating actions. The charging stop planning assistant is able to record the recorded variable and estimate the estimated value. The charging stop planning assistant can also learn the behavior of a particular user by evaluating which charging stations with which attributes are preferred by the person driving the vehicle to carry out charging stops. This enables the charging stop planning assistant to facilitate a particularly convenient charging process for the person driving the vehicle.

According to the invention, a vehicle has an integrated charging stop planning assistant. The vehicle can be any vehicle such as a car, lorry, van, bus or even a small vehicle such as an e-bike or an e-scooter. Corresponding vehicle components can be used as the human-machine interface, such as the instrument cluster, the head unit, dashboard controls or similar. In general, however, it is also possible to run the charging stop planning assistant according to the invention on a mobile device such as a smartphone, tablet computer, laptop or the like. However, the charging stop planning assistant integrated into the vehicle ensures a particularly high level of user convenience, as the person driving the vehicle does not have to operate any separate devices. It is particularly preferable that the person driving the vehicle does not have to enter any separate operating actions to use the charging stop planning assistant. Suitable charging stations are therefore suggested automatically.

Further advantageous embodiments of the method according to the invention for determining an intelligent preselection of suitable charging stations for carrying out a charging stop also result from the exemplary embodiments, which are described in more detail below with reference to the figures.

### BRIEF DESCRIPTION OF THE DRAWING FIGURES

Here:

FIG. 1 shows a schematic representation of a vehicle according to the invention having a charging stop planning assistant; and

FIG. 2 shows a flow diagram of a method according to the invention.

### DETAILED DESCRIPTION

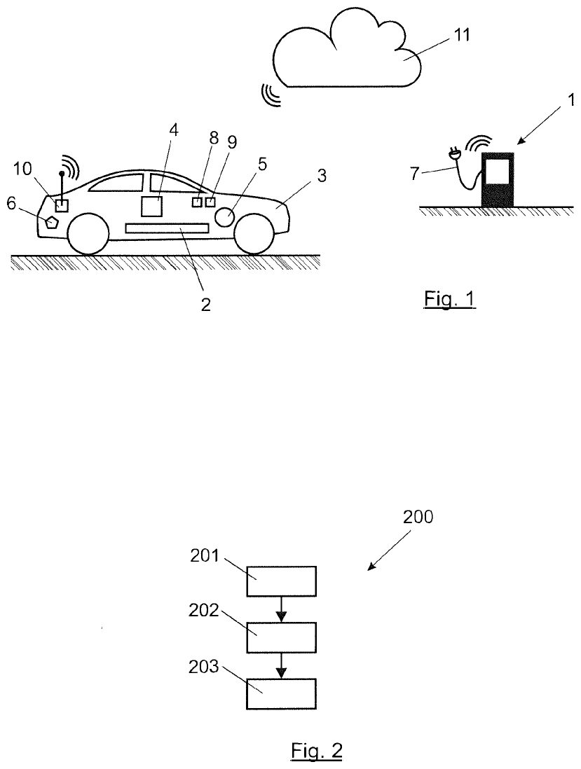

FIG. 1 shows a vehicle 3 according to the invention, which can be battery-powered. For this purpose, the vehicle 3 comprises at least one traction battery 2 and at least one electric drive engine 5. The vehicle 3 can also be designed as a hybrid vehicle. Furthermore, the vehicle 3 has a charging interface 6 for connecting a charging cable 7, with which the vehicle 3 can be supplied with electrical energy via a charging station 1.

The vehicle 3 also comprises a computer unit 4 on which a charging stop planning assistant according to the invention is run. For interaction with a person driving the vehicle, the vehicle 3 also has at least one display 8 and at least one device for entering operating actions 9. The vehicle 3 or the computer unit 4 can exchange data with a central computer unit 11 external to the vehicle via a wireless communication interface 10. For example, the vehicle 3 can receive information from the central processing unit 11 about charging stations 1 located in the vicinity of the vehicle 3. In addition to a position of the charging stations 1, this also includes charging station-specific attributes such as a currently offered electricity price, a current utilization of the charging station 1, a charging interface that can be used by the charging station 1, and an available type of electricity or the like.

In general, a charging station 1 can also communicate with the central computer unit 11. Such communication can be wireless, for example via mobile radio, WiFi or similar, or also wired. In this way, a charging station 1 can, for example, inform the central computer unit 11 of the times at which a charging process has already been reserved at the charging station 1 by a third-party vehicle.

For particularly convenient planning of charging stops, a method 200 shown in FIG. 2 is carried out. For this purpose, at least one measurable variable in the form of at least one vehicle requirement, user requirement and/or environmental factor is recorded in a first process step 201. For example, a charge level of the traction battery 2 is monitored, an oil temperature is monitored, a state of health of the person driving the vehicle is monitored, a time is recorded, an outside temperature is measured, and/or similar.

In a subsequent process step 202, a value of a further vehicle requirement, user requirement, environmental factor, and/or a journey-specific factor that differs from the recorded variable is estimated from at least one of the recorded variables. For example, it can be estimated from a time of day that the person driving the vehicle is hungry, as this is a typical time for lunch. A discharged traction battery can be used to estimate that the person driving the vehicle has an urge to urinate, as the person driving the vehicle has been travelling in the vehicle 3 for a comparatively long time. Similarly, an operating time of the vehicle 3 can also be recorded. A dwell time can be derived from the current location of the vehicle 3. If the dwell time is comparatively long, such as 45 minutes, a recommendation can be issued for travelling to a charging station. If the dwell time is comparatively short, such as 6 minutes, no such recommendation is issued.

In the process step 203 following the process step 202, the charging stop planning assistant then outputs suitable charging stations for carrying out the charging stop. For example, the charging stations can be displayed on a map or in a list. The list can be organized according to a convenience value or usefulness value for the person driving the vehicle. Particularly useful, i.e., convenient, charging stations are displayed first in the list. Similarly, the list can also be sorted according to the distance of the charging stations to the current vehicle position. The person driving the vehicle can select one or more suggested charging stations 1, whereupon additional information, such as the attributes of these charging station(s) 1, is displayed. In this way, the person driving the vehicle can obtain a detailed overview of the charging stations 1 that are potentially suitable for carrying out the charging stop before deciding to drive to a particular charging station 1.

Although the invention has been illustrated and described in detail by way of preferred embodiments, the invention is not limited by the examples disclosed, and other variations can be derived from these by the person skilled in the art without leaving the scope of the invention. It is therefore clear that there is a plurality of possible variations. It is also clear that embodiments stated by way of example are only really examples that are not to be seen as limiting the scope, application possibilities or configuration of the invention in any way. In fact, the preceding description and the description of the figures enable the person skilled in the art to implement the exemplary embodiments in concrete manner, wherein, with the knowledge of the disclosed inventive concept, the person skilled in the art is able to undertake various changes, for example, with regard to the functioning or arrangement of individual elements stated in an exemplary embodiment without leaving the scope of the invention, which is defined by the claims and their legal equivalents, such as further explanations in the description.

1-7. (canceled)

8. A method for selecting a charging station for a charging stop for charging a traction battery of an electrically drivable vehicle, the method comprising:
recording a variable of at least one vehicle requirement, user requirement, or environmental factor;
estimating, using the recorded variable, a value of at least one vehicle requirement, user requirement, environmental factor, or a journey-specific factor deviating from the recorded variable;
outputting a suggestion of at least one suitable charging station for the charging stop for the vehicle, wherein the outputted suggestion is based on the recorded variable and the estimated value by comparing the at least one vehicle requirement, user requirement, environmental factor, or journey-specific factor with at least one charging station-specific attribute of a charging station.

9. The method of claim 8, wherein
the vehicle requirement is based on a charging level of a traction battery, a tire pressure, an oil temperature, a coolant temperature, or a defect of a vehicle component,
the user requirement is based on hunger, thirst, need to urinate, fatigue, protection, or exhaustion,
the environmental factor is based on a time, a day of week, a time of year, climate conditions, or existence of a facility located up to a specified distance from a charging station in proximity of the charging station, or
the journey-specific factor is a route driven with the vehicle, a length of the route, a duration of time required to cover at least one section of the route, a seat occupancy, or a dwell time of the vehicle at a place.

10. The method of claim 8, wherein a charging station that has been visited at least once with the vehicle for charging is marked as a historical charging station, and charging stations marked as historical are output as suggestions for carrying out further charging stops.

11. The method of claim 10, wherein at least one attribute of a historical charging station is recorded and at least one charging station other than a historical charging station, which has the at least one attribute of the historical charging station, is output as a suggestion for carrying out further charging stops.

12. The method of claim 8, wherein the at least one station-specific attribute of the charging station is one of:
a specific charging interface;
a specific current type, in particular a charging voltage, a charging current, a charging capacity, or a frequency;
an electricity price;
an operator of the charging station;
an energy supplier;
a bonus program;
a payment method;
existing weather protection;
a current, planned, or an average occupancy;
available lighting; or
a facility existing up to a specific distance in the proximity of the charging station.

13. A charging stop planning assistant, comprising:
a human-machine interface configured to record a variable of at least one vehicle requirement, user requirement, or environmental factor; and
a computer unit, coupled to the human-machine interface, configured to estimate, using the recorded variable, a value of at least one vehicle requirement, user requirement, environmental factor, or a journey-specific factor deviating from the recorded variable, and
wherein the human-machine interface is configured to output a suggestion of at least one suitable charging station for the charging stop for the vehicle, wherein the outputted suggestion is based on the recorded variable and the estimated value by comparing the at least one vehicle requirement, user requirement, environmental factor, or journey-specific factor with at least one charging station-specific attribute of a charging station.

14. A vehicle comprising:
an integrated charging stop planning assistant, which comprises a human-machine interface configured to record a variable of at least one vehicle requirement, user requirement, or environmental factor; and
a computer unit, coupled to the human-machine interface, configured to estimate, using the recorded variable, a value of at least one vehicle requirement, user requirement, environmental factor, or a journey-specific factor deviating from the recorded variable, and
wherein the human-machine interface is configured to output a suggestion of at least one suitable charging station for the charging stop for the vehicle, wherein the outputted suggestion is based on the recorded variable and the estimated value by comparing the at least one vehicle requirement, user requirement, environmental factor, or journey-specific factor with at least one charging station-specific attribute of a charging station.
